(19) United States
(12) Patent Application Publication
(10) Pub. No.: US 2026/0251185 A1
(43) Pub. Date: Aug. 27, 2026

(54) SELF-LUBRICATING UNIVERSAL JOINT

(71) Applicant: ARRAY TECH, INC., Albuquerque, NM (US)

(72) Inventor: Jose Martin, Queen Creek, AZ (US)

(21) Appl. No.: 19/538,161

(22) Filed: Feb. 12, 2026

Related U.S. Application Data
(60) Provisional application No. 63/762,884, filed on Feb. 25, 2025.

(51) Int. Cl. F16D 3/38; F24S 30/425; H02S 20/32; F24S 30/00

(52) U.S. Cl. CPC F16D 3/385; F24S 30/425; H02S 20/32; F24S 2030/136; Y02E 10/47; Y10S 384/908; Y10S 384/91

(57) ABSTRACT

A universal joint (U-joint) for a solar tracker system may include a cross member including a central body and four trunnions extending outwardly from the central body. Each trunnion may be coupled to a bushing having a self-lubricating inner surface. The U-joint may include a first yoke configured to be coupled to a driveshaft and a second yoke configured to be coupled to a driveline. The first yoke may include a first arm and a second arm, and each arm may define an aperture. The aperture of the first and second arms may couple the first and second arms to a respective self-lubricating bushing. The second yoke may include a third arm and a fourth arm, and each arm may define an aperture. The aperture of the third and fourth arms may couple the third and fourth arms to a respective self-lubricating bushing.

### CROSS-REFERENCE TO RELATED APPLICATIONS

This patent application claims priority to and the benefit of United States Provisional Patent Application Serial No. 63/762,884, entitled SELF-LUBRICATING UNIVERSAL JOINT, filed Feb. 25, 2025, which is incorporated by reference in its entirety.

### FIELD

The present disclosure relates to solar energy production and more particularly to a self-lubricating U-joint for a solar tracker system.

### BACKGROUND

Solar tracker systems typically include multiple solar tracker rows and operate by rotating photovoltaic (PV) modules secured to each solar tracker row to align the PV modules with the position of the Sun. As a result, the PV modules’ exposure to sunlight throughout the day may be increased. This functionality ensures that PV modules in solar tracker systems remain positioned to capture higher levels of solar radiation, which may enhance the overall efficiency of solar power generation.

Universal joints (U-joints) are commonly used in mechanical power transmission systems to connect rotating shafts that may not be aligned. In solar tracker systems, U-joints may be employed to transfer rotational motion from a driveshaft (e.g., a motor driveshaft or a gear drive mechanism driveshaft) to drivelines that may transmit the rotational motion to one or more solar tracker rows. Conventional U-joints typically utilize needle bearings to allow relative rotation between the joint components.

The subject matter claimed in the present disclosure is not limited to embodiments that solve any disadvantages or that operate only in environments such as those described above.

Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Needle bearings in U-joints may have limitations when used in solar tracker applications. The bearings require regular lubrication to function properly and prevent premature wear. Furthermore, solar tracker systems may be implemented in remote areas and/or use hundreds or even thousands of U-joints with each joint utilizing multiple needle bearings. As a result, needle bearings may not be lubricated as often is recommended and/or may not be lubricated at all, which may result in failure. However, even with proper lubrication, needle bearings may be prone to failure under the high torque, low speed conditions often encountered in solar tracker systems.

Needle bearings are frequently used in high RPM, low torque environments, but the operating conditions in solar tracker systems, with low rotational speeds and high torque loads, may not be ideal for needle bearing performance. The limited contact area between the needle rollers and races may also result in high contact stresses under heavy torque loads, which may cause the needle bearings to fail prematurely. As a result, the torque capacity of the U-joint may be limited due to the needle bearings.

Additionally, the harsh outdoor environments where solar tracker systems are typically located may accelerate bearing degradation. Exposure to dust, moisture, and/or temperature extremes may compromise bearing lubrication and seals over time. This may lead to increased maintenance requirements or premature joint failures.

Solar tracker systems continue to grow in size and scale, placing greater demands on mechanical components like U-joints. Accordingly, there is a need for a U-joint that may reliably handle high torque, low RPM environments while requiring less maintenance over the service life of the U-joint. Improved U-joint performance and longevity may enhance the overall reliability and reduce lifecycle costs for solar tracker systems.

Example embodiments of the present disclosure may address problems experienced in utilizing needle bearings in universal-joints (U-joint) in solar tracker systems, including limited torque capacity and high contact stress. Embodiments disclosed herein may address these problems by providing a U-joint for a solar tracker system that may withstand high torque and low RPM conditions. The U-joint may include bushings having a self-lubricating inner surface, which may be more suitable for use in the high torque, low RPM environments often encountered in solar tracker systems.

The U-joint may include a cross member having a central body, a first trunnion, a second trunnion, a third trunnion opposite the first trunnion, and a fourth trunnion opposite the second trunnion. Each trunnion may extend outwardly from the central body, and each trunnion may be coupled to a bushing having a self-lubricating inner surface. For example, the first trunnion may be coupled to a first bushing, the second trunnion may be coupled to a second bushing, the third trunnion may be coupled to a third bushing, and the fourth trunnion may be coupled to a fourth bushing. The U-joint may include a first yoke configured to be coupled to a driveshaft and a second yoke configured to be coupled to a driveline. The first yoke may include a first arm and a second arm, and the second yoke may include a third arm and a fourth arm. The arms of the first yoke may each define an aperture, and the arms of the second yoke may each define an aperture. The aperture of the first arm may couple the first arm to the first bushing, the aperture of the second arm may couple the second arm to the third bushing, the aperture of the third arm may couple the third arm to the second bushing, and the aperture of the fourth arm may couple the fourth arm to the fourth bushing.

In some embodiments, each bushing may be a cap having a blind hole. In these and other embodiments, the blind hole of the first bushing may receive the first trunnion, the blind hole of the second bushing may receive the second trunnion, the blind hole of the third bushing may receive the third trunnion, and the blind hole of the fourth bushing may receive the fourth trunnion. In some embodiments, each bushing may be a sleeve having a through hole. In these and other embodiments, the through hole of the first bushing may receive the first trunnion, the through hole of the second bushing may receive the second trunnion, the through hole of the third bushing may receive the third trunnion, and the through hole of the fourth bushing may receive the fourth trunnion.

In some embodiments, the self-lubricating inner surface may include a layer of at least one of: polytetrafluoroethylene (PTFE), molybdenum disulfide, ultra-high molecular weight polyethylene (UHMWPE), polyoxymethylene (POM), or polyetheretherketone (PEEK). In some embodiments, the self-lubricating inner surface may include a PTFE layer. In some embodiments, each bushing may include a metal backplane to which the PTFE layer may be applied. In some embodiments, the PTFE layer may be a PTFE tape or a PTFE powder. In some embodiments, the PTFE powder may be applied to a porous metal layer attached to the metal backplane. In some embodiments, the PTFE powder may be applied to a stretched metal layer attached to the metal backplane.

In another embodiment, a solar tracker system may include a photovoltaic (PV) module coupled to a torque tube such that rotation of the torque tube rotates the PV module. The solar tracker system may also include a motor configured to generate a rotational force. A driveline assembly may be coupled to the motor and may include a driveline configured to transmit the rotational force from the motor to the torque tube such that the rotational force causes the torque tube to rotate.

The driveline assembly may further include a U-joint configured to transmit the rotational force from the motor to the driveline. The U-joint may include a cross member including a central body, a first trunnion, a second trunnion, a third trunnion opposite the first trunnion, and a fourth trunnion opposite the second trunnion. Each trunnion may extend outwardly from the central body. The U-joint may also include bushings coupled to each trunnion, and each bushing may have a self-lubricating inner surface. A first yoke may be coupled to the motor and a second yoke may be coupled to the driveline, and each yoke may include arms coupled to the bushings.

Overall, the self-lubricating inner surface of the bushings in the embodiments disclosed may increase the torque capacity of the U-joint relative to the needle bearings currently used, which may enable the U-joint and the bushings to operate in the high torque, low RPM conditions often encountered in solar tracker systems. Furthermore, utilizing self-lubricating bushings may eliminate the need for manual lubrication, extend the life of the U-joint, and/or reduce the amount of U-joint maintenance over the life of the U-joint. As a result, U-joint performance and longevity in solar tracker systems may be improved, which may reduce costs and enhance the overall reliability of solar tracker systems.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example solar tracker system including one or more solar tracker rows;

FIG. 2 is a partial view of an example solar tracker system showing two solar tracker rows;

FIG. 3A is a perspective exploded view of a solar tracker system including a driveline assembly, a motor, a gear drive mechanism, and a torque tube;

FIG. 3B is a top exploded view of the solar tracker system shown in FIG. 3A;

FIG. 4 is a perspective view of a U-joint including a bearing having a self-lubricating inner surface;

FIG. 5 is an exploded view of the U-joint shown in FIG. 4;

FIG. 6 is a perspective view of the bearing having a self-lubricating inner surface utilized in the U-joint shown in FIG. 4;

FIG. 7 is a perspective view of another U-joint including a bearing having a self-lubricating inner surface;

FIG. 8 is an exploded view of the U-joint shown in FIG. 7;

FIG. 9 is a perspective view of the bearing having the self-lubricating inner surface utilized in the U-joint shown in FIG. 7;

FIG. 10 shows various bushing configurations; and

FIG. 11 illustrates various cross-sectional views of different bushing configurations.

All in accordance with one or more embodiments in the present disclosure.

### DETAILED DESCRIPTION

Embodiments of the present disclosure are explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

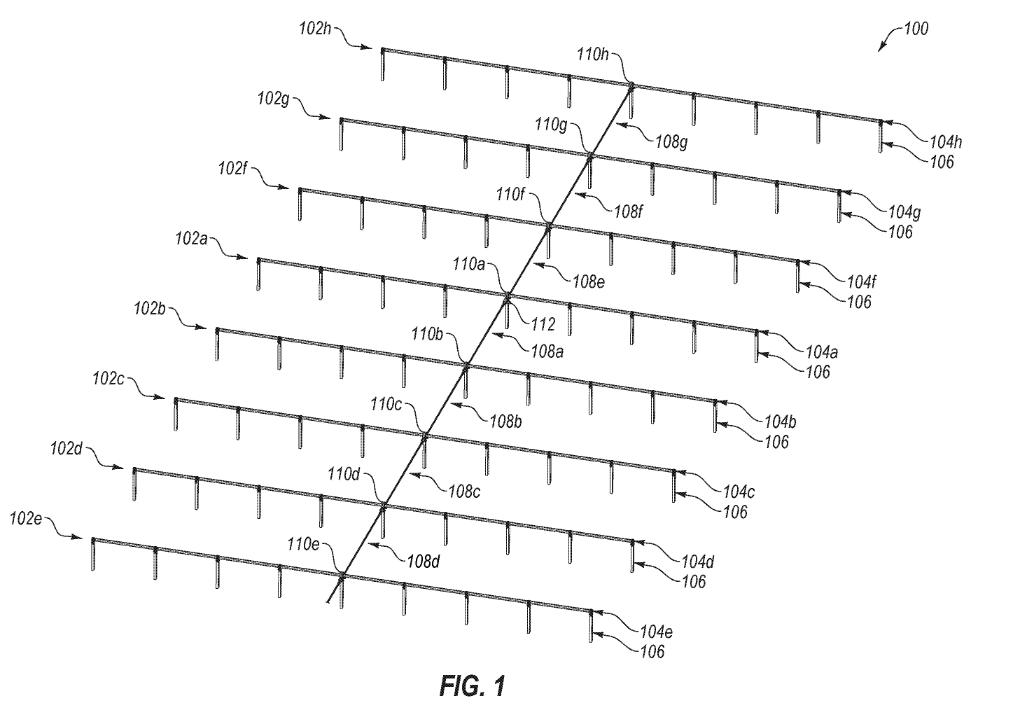

FIG. 1 illustrates an example solar tracker system 100. The solar tracker system 100 may include one or more solar tracker rows 102. Each solar tracker row 102 may include a torque tube 104 coupled to one or more PV modules (not shown) such that rotation of the torque tube 104 rotates the PV modules. For example, a first solar tracker row 102a may include a first torque tube 104a coupled to one or more first PV modules such that rotation of the first torque tube 104a rotates the first PV modules, a second solar tracker row 102b may include a second torque tube 104b coupled to one or more second PV modules such that rotation of the second torque tube 104b rotates the second PV modules, and/or a third solar tracker row 102c may include a third torque tube 104c coupled to one or more third PV modules such that rotation of the third torque tube 104c rotates the third PV modules. Thus, the torque tubes 104 may rotate the PV modules such that the PV modules may track the position of the Sun in the sky throughout the day. For example, as the Sun rises and early in the day, the PV modules may be rotated by the torque tubes 104 such that the PV modules may be facing an easterly direction, around mid-day the PV modules may be rotated by the torque tubes 104 such that the PV modules may be substantially horizontal, and as the Sun sets and later in the day, the PV modules may be rotated by the torque tubes 104 such that the PV modules may be facing a westerly direction. Additionally or alternatively, the PV modules may be rotated by the torque tubes 104 in response to weather events such as hailstorms or snowstorms, for maintenance purposes, and/or in response to other factors other than to track the position of the Sun.

The solar tracker system 100 may also include one or more support columns (or piles) 106. The support columns 106 may be driven into the ground and may provide vertical support for the PV modules and the torque tubes 104. The torque tubes 104 may provide horizontal support for the PV modules.

In some embodiments, at least one of the solar tracker rows 102 may include a motor 112. For example, the first solar tracker row 102a may include the motor 112. In some embodiments, the motor 112 may be an electric motor such as an AC motor or a DC motor. In some embodiments, the motor 112 may be a brushed motor or a brushless motor. The motor 112 may exert a rotational force that may be transmitted to the torque tubes 104 such that the PV modules may be rotated.

The first solar tracker row 102a may include the motor 112 and may be placed at various positions in the solar tracker system 100. In some embodiments, and as illustrated in FIG. 1, the first solar tracker row 102a may be a middle row in the solar tracker system 100 such that there may be solar tracker rows 102 on both sides of the first solar tracker row 102a. In these embodiments, the rotational force exerted by the motor 112 may be transmitted in multiple directions. For example, and as illustrated in FIG. 1, the rotational force exerted by the motor 112 may be transmitted in a first direction from the first solar tracker row 102a to the second solar tracker row 102b, the third solar tracker row 102c, a fourth solar tracker row 102d, and/or a fifth solar tracker row 102e, and the rotational force exerted by the motor 112 may be transmitted in a second direction from the first solar tracker row 102a to a sixth solar tracker row 102f, a seventh solar tracker row 102g, and/or an eight solar tracker row 102h. It will be appreciated that the term middle row is used to encompass the first solar tracker row 102a having at least one solar tracker row 102 on either side of the first solar tracker row 102a. In some embodiments, the first solar tracker row 102a may have equivalent numbers of solar tracker rows 102 on either side of the first solar tracker row 102a, but in some embodiments the number of solar tracker rows 102 on either side of the first solar tracker row 102a may be different.

In some embodiments, the first solar tracker row 102a may be an end row in the solar tracker system 100. For example, the first solar tracker row 102a may be in the position of the fifth solar tracker row 102e or the eighth solar tracker row 102h, which may be end rows as shown in FIG. 1. Therefore, in some embodiments, other solar tracker rows 102 may be on only one side of the first solar tracker row 102a. In these and other embodiments, the rotational force exerted by the motor 112 may be transmitted in one direction.

The solar tracker system 100 may include one or more driveline assemblies 108 coupling the solar tracker rows 102. For example, the first solar tracker row 102a may be coupled to the second solar tracker row 102b via a first driveline assembly 108a, and the second solar tracker row 102b may be coupled to a third solar tracker row 102c via a second driveline assembly 108b. The driveline assemblies 108 may include a driveline and one or more U-joints. The rotational force from the motor 112 may cause the driveline assemblies 108 to rotate at low revolutions per minute but may cause the driveline assemblies 108 to experience high torque. The driveline assemblies 108 may transmit the rotational force from one solar tracker row 102 to the torque tube 104 at the next solar tracker row 102. For example, the first driveline assembly 108a may transmit the rotational force exerted by the motor 112 at the first solar tracker row 102a to the second torque tube 104b at the second solar tracker row 102b, and the second driveline assembly 108b may transmit the rotational force exerted by the motor 112 from the second solar tracker row 102b to the third torque tube 104c at the third solar tracker row 102c.

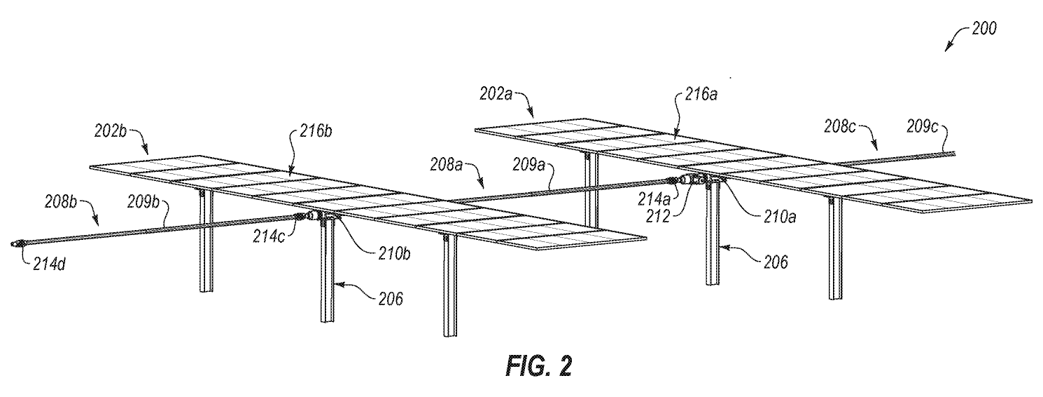

The U-joints may couple the driveline assemblies 108 to the solar tracker rows 102 at each end of the driveline assemblies 108. The U-joints may be configured to transmit the rotational force from the motor 112 to the driveline. For example, a first U-joint of the first driveline assembly 108a may couple the first driveline to the motor 112 and may transmit the rotational force from the motor 112 to the driveline, and a second U-joint of the first driveline assembly 108a may couple the first driveline to the second solar tracker row 102b. The driveline assemblies 108 and/or components of the driveline assemblies 108 such as the driveline and the U-joints are described with more detail with reference to FIGS. 2 - 11.

In some embodiments, each solar tracker row 102 may include a gear drive mechanism 110 coupled to the torque tube 104, and the gear drive mechanism 110 may cause the torque tubes 104 to rotate due to the rotational force exerted by the motor 112—thereby rotating the PV modules. For example, a first gear drive mechanism 110a may be coupled to the first torque tube 104a and may cause the first torque tube 104a to rotate due to the rotational force exerted by the motor 112, and a second gear drive mechanism 110b may be coupled to the second torque tube 104b and may cause the second torque tube 104b to rotate due to the rotational force exerted by the motor 112.

In some embodiments, the gear drive mechanism 110 may be a slew drive, a worm gear drive, a bevel gear drive, a planetary gear drive, a cycloidal drive, a helical gear drive, a harmonic drive, a spur gear drive, a rack and pinion drive, a combination of gear drive mechanisms, or any other suitable gear drive mechanism. For example, in some embodiments, the gear drive mechanisms 110 may be a slew drive including a worm gear. For instance, both the first gear drive mechanism 110a and the second gear drive mechanism 110b may be slew drives including a worm gear.

In some embodiments, the motor 112 may be directly coupled to at least one of the gear drive mechanisms 110. For example, the motor 112 may be directly coupled to the first gear drive mechanism 110a, and the rotational force exerted by the motor 112 may be directly transmitted from the motor 112 to the first gear drive mechanism 110a such that the first gear drive mechanism 110a rotates the first torque tube 104a. In some embodiments, the driveline assemblies 108 may couple the motor 112 to one or more of the gear drive mechanisms 110. For example, the driveline assemblies 108 between the solar tracker rows 102 may transmit the rotational force exerted by the motor 112 to the gear drive mechanisms 110. For instance, the rotational force exerted by the motor 112 may be transmitted to the first U-joint coupled to the motor 112, the first U-joint may transmit the rotational force from the motor 112 to the driveline, the driveline may transmit the rotational force from the motor 112 to the second U-joint, and the second U-joint may transmit the rotational force from the driveline to the second gear drive mechanism 110b, which may rotate the second torque tube 104b thereby causing the second PV modules at the second solar tracker row 102b to rotate.

In an example operation of the solar tracker system 100, the motor 112 at the first solar tracker row 102a may exert a rotational force. The motor 112 may be coupled to the first gear drive mechanism 110a which may be coupled to the first torque tube 104a. The rotational force from the motor 112 may cause the first gear drive mechanism 110a to rotate the first torque tube 104a thereby causing the first PV modules at the first solar tracker row 102a to rotate. The first driveline assembly 108a may be coupled at one end to the motor 112 and at another end to the second solar tracker row 102b. The first driveline assembly 108a may transmit the rotational force exerted by the motor 112 to the second gear drive mechanism 110b, which may cause the second gear drive mechanism 110b to rotate the second torque tube 104b thereby causing the second PV modules to rotate.

The second driveline assembly 108b may be coupled at one end to the second solar tracker row 102b and at another end to the third solar tracker row 102c. For example, the second driveline assembly 108b may be coupled to the second gear drive mechanism 108b at one end and to a third gear drive mechanism 110c at another end. The second driveline assembly 108b may transmit the rotational force exerted by the motor 112 from the second gear drive mechanism 110b to the third gear drive mechanism 110c, which may cause the third gear drive mechanism 110c to rotate the third torque tube 104c thereby causing the third PV modules to rotate.

The rotational force may be further transmitted to additional solar tracker rows in the solar tracker system 100 in a similar manner as that described above. For example, a third driveline assembly 108c may transmit the rotational force from the third gear drive mechanism 110c to a fourth gear drive mechanism 110d at the fourth solar tracker row 102d, and/or a fourth driveline assembly 108d may transmit the rotational force from the fourth gear drive mechanism 110d to a fifth gear drive mechanism 110e at the fifth solar tracker row 102e. Additionally, the rotational force may be transmitted in the opposite direction from the motor 112. For example, the motor 112 may be coupled to the first gear drive mechanism 110a, and the first gear drive mechanism 110a may transmit the rotational force from the motor 112 to a fifth driveline assembly 108e coupling the first solar tracker row 102a to the sixth solar tracker row 102f. The fifth driveline assembly 108e may transmit the rotational force from the first gear drive mechanism 110a to a sixth gear drive mechanism 110g, which may cause the sixth gear drive mechanism 110g to rotate a sixth torque tube 104g causing one or more sixth PV modules to rotate. The rotational force from the motor 112 may be transmitted further in this direction to additional solar tracker rows 102 with additional driveline assemblies 108.

Modifications, additions, or omissions may be made to the solar tracker system 100 without departing from the scope of the present disclosure. For example, the solar tracker system 100 may have more or less solar tracker rows 102 depending on the configuration of the solar tracker system 100. As illustrated, the first solar tracker row 102a having the motor 112 may be a middle row, but, in some embodiments, the first solar tracker row 102a may be an end row. Furthermore, in some embodiments, multiple motors 112 may be utilized. For example, a first motor may transmit a rotational force to the first solar tracker row 102a, the second solar tracker row 102b, the third solar tracker row 102c , the fourth solar tracker row 102d, and/or the fifth solar tracker row 102e, and a second motor may transmit a rotational force to the sixth solar tracker row 102f, the seventh solar tracker row 102g, and/or the eighth solar tracker row 102h.

Furthermore, the components illustrated in FIG. 1 and described in FIG. 1, may be similar to, have similar features as, or perform similar functions as similarly named components described throughout this disclosure. For example, the U-joints in the driveline assemblies 108 may be similar to the U-joints described throughout this disclosure and may utilize the bushings described throughout this disclosure.

FIG. 2 illustrates a partial view of an example solar tracker system 200. The solar tracker system 200 may include a first solar tracker row 202a and a second solar tracker row 202b. The first solar tracker row 202a may include one or more first PV modules 216a, a first torque tube (not shown), and a motor 212. The first torque tube may be coupled to the first PV modules 216a such that rotation of the first torque tube rotates the first PV modules 216a. The second solar tracker row 202b may include one or more second PV modules 216b and a second torque tube (not shown). The second torque tube may be coupled to the second PV modules 216b such that rotation of the second torque tube rotates the second PV modules 216b. The solar tracker system 200 may also include one or more support columns (or piles) 206. The support columns 206 may be driven into the ground and may provide vertical support for the PV modules 216 and the torque tubes. The torque tubes may provide horizontal support for the PV modules 216.

The motor 212 may exert a rotational force that may cause the torque tubes at the solar tracker rows 202 to rotate. For example, the motor 212 may exert a rotational force that rotates the first torque tube at the first solar tracker row 202a. As described previously, in some embodiments, the motor 212 may be an electric motor such as a DC motor.

In some embodiments, the solar tracker rows 202 may include a gear drive mechanism 210. For example, the first solar tracker row 202a may include a first gear drive mechanism 210a coupled to the first torque tube, and the second solar tracker row 202b may include a second gear drive mechanism 210b coupled to the second torque tube. In some embodiments, the first gear drive mechanism 210a and the second gear drive mechanism 210b may be slew drives including a worm gear. In some embodiments, the gear drive mechanisms 210 may be a slew drive, a worm gear drive, a bevel gear drive, a planetary gear drive, a cycloidal drive, a helical gear drive, a harmonic drive, a spur gear drive, a rack and pinion drive, a combination of gear drive mechanisms, or any other suitable gear drive mechanism.

The solar tracker system 200 may also include one or more driveline assemblies 208 that may couple one solar tracker row 202 to another solar tracker row 202. For example, a first driveline assembly 208a may couple the first solar tracker row 202a to the second solar tracker row 202b. Each of the driveline assemblies 208 may include a driveline 209 and one or more U- joints 214. For example, the first driveline assembly 208a may include a first driveline 209a that may transmit the rotational force from the motor 212 at the first solar tracker row 202a to the second torque tube at the second solar tracker row 202b, and the first driveline assembly 208a may also include a first U-joint 214a coupling the first driveline 209a to the motor 212. The first U-joint 214a may transmit the rotational force from the motor 212 to the first driveline 209a.

The first driveline assembly 208a may further include a second U-joint (not shown) coupling the first driveline 209a to the second solar tracker row 202b. In some embodiments, the second U-joint may couple the first driveline 209a to the second gear drive mechanism 210b at the second solar tracker row 202b. In these and other embodiments, the second U-joint may transmit the rotational force to the second gear drive mechanism 210b such that the second gear drive mechanism 210b causes the second torque tube to rotate.

In some embodiments, the solar tracker system 200 may include a second driveline assembly 208b, and the second driveline assembly 208b may couple the second solar tracker row 202b to a third solar tracker row (not shown). The third solar tracker row may include one or more third PV modules and a third torque tube coupled to the third PV modules such that rotation of the third torque tube rotates the third PV modules. The second driveline assembly 208b may include a second driveline 209b that may transmit the rotational force from the first driveline 209a to the third torque tube. For example, the first driveline 209a may transmit the rotational force to the second gear drive mechanism 210b which may transmit the rotational force to the second driveline 209b, which may further transmit the rotational force to the third torque tube. The second driveline assembly 208b may include a third U-joint 214c and a fourth U-joint 214d. The third U-joint 214c may couple the second driveline 209b to the second solar tracker row 202b and may transmit the rotational force to the second driveline 209b. For example, the third U-joint 214c may be coupled to the second gear drive mechanism 210b and the third U-joint 214c may transmit the rotational force from the second gear drive mechanism 210b to the second driveline 209b. The fourth U-joint 214d may couple the second driveline 209b to the third solar tracker row and may transmit the rotational force from the second driveline 209b to the third torque tube. For example, the fourth U-joint 214d may couple the second driveline 209b to a third gear drive mechanism at the third solar tracker row, which may cause the third torque tube to rotate thereby rotating the third PV modules.

In some embodiments, the drivelines 209 may be between about 5 feet and about 40 feet in length. In some embodiments, the drivelines 209 may be substantially the same length such that the solar tracker rows 202 may be separated by equivalent or nearly equivalent distances. For example, the first driveline 209a and the second driveline 209b may be both about 25 feet in length. In some embodiments, the drivelines 209 may have different lengths such that the solar tracker rows 202 may be separated by varying distances. For example, the first driveline 209a may be about 20 feet long and the second driveline 209b may be about 25 feet long.

The one or more U-joints 214 included in the driveline assemblies 208 may be configured to transmit the rotational force from the motor 212 to the drivelines 209. The U-joints 214 may include a cross member including a central body, a first trunnion, a second trunnion, a third trunnion opposite the first trunnion, and a fourth trunnion opposite the second trunnion. Each trunnion may extend outwardly from the central body. The U-joints 214 may also include one or more bushings having a self-lubricating inner surface. For example, a first bushing may be coupled to the first trunnion, a second bushing may be coupled to the second trunnion, a third bushing may be coupled to the third trunnion, a fourth bushing may be coupled to the fourth trunnion, and each of the bushings may have a self-lubricating inner surface. The U-joints 214 may include a first yoke that may be coupled to a driveshaft. For example, the first yoke of the first U-joint 214a may be coupled to the driveshaft of the motor 212. In another example, the first yoke of the third U-joint 214c may be coupled to the driveshaft of the second gear drive mechanism 210b. The U-joints 214 may include a second yoke that may be coupled to a driveline 209. For example, the second yoke of the first U-joint 214a may be coupled to the first driveline 209a. The first yoke may include a first arm and a second arm and the second yoke may include a third arm and a fourth arm. Each arm may define an aperture. The aperture of the first arm may couple the first arm of the first yoke to the first bushing, the aperture of the second arm may couple the second arm of the first yoke to the third bushing, the aperture of the third arm may couple the third arm of the second yoke to the second bushing, and the aperture of the fourth arm may couple the fourth arm of the second yoke to the fourth bushing.

In an example operation of the solar tracker system 200, the motor 212 at the first solar tracker row 202a may exert a rotational force. The first gear drive mechanism 210a may be coupled to the first torque tube at the first solar tracker row 202a and the first gear drive mechanism 210a may transmit the rotational force exerted by the motor 212 to the first torque tube such that the first PV modules 216a may be rotated to track the position of the Sun. The first U-joint 214a may couple the first driveline 209a to the motor 212 and may transmit the rotational force from the motor 212 to the first driveline 209a, which may rotate the first U-joint 214a and the first driveline 209a. The first driveline 209a may transmit the rotational force from the motor 212 to the second torque tube at the second solar tracker row 202b. For example, the first driveline 209a may be coupled to the second U-joint, which may couple the first driveline 209a to the second solar tracker row 202b, and the second U-joint may transmit the rotational force from the first driveline 209a to the second torque tube. For instance, the second U-joint may be coupled to the second gear drive mechanism 210b, which may be coupled to the second torque tube such that rotation of the second U-joint causes the second gear drive mechanism 210b to rotate the second torque tube. As a result, the second PV modules 216b may be rotated.

In some embodiments, the rotational force from the motor 212 may be transmitted further in the same direction. For example, the third U-joint 214c may couple the second driveline 209b to the second solar tracker row 202b. The second gear drive mechanism 210b may transmit the rotational force to the third U-joint 214c causing the third U-joint 214c to rotate, which may transmit the rotational force to the second driveline 209b causing the second driveline 209b to rotate. The second driveline 209b may transmit the rotational force to a fourth U-joint 214d coupling the second driveline 209b to the third solar tracker row (not shown), which may cause the fourth U-joint 214d to rotate. The fourth U-joint 214d may transmit the rotational force from the second driveline 209b to the third torque tube at the third solar tracker row via, for example, a third gear drive mechanism. Additional solar tracker rows 202 may be implemented in the same direction, and the rotational force may be transmitted to the additional solar tracker rows 202 using similar components.

In some embodiments, the rotational force from the motor 212 may be transmitted in an opposite direction from the first solar tracker row 202a. For example, the motor 212 may be included at a middle solar tracker row as illustrated in FIG. 2. In these and other embodiments, the rotational force may be transmitted in one direction towards one or more solar tracker rows 202 and in another direction towards one or more other solar tracker rows 202. For example, the first solar tracker row 202a may be coupled to a fourth solar tracker row (not shown) via a third driveline assembly 208c. The fourth solar tracker row may be on an opposite side of the first solar tracker row 202a as the second solar tracker row 202b and the third solar tracker row. The third driveline assembly 208c may transmit the rotational force from the motor 212 to the fourth solar tracker row. The third driveline assembly 208c may include a fifth U-joint (not shown), a sixth U-joint (not shown), and a third driveline 209c. For example, the third driveline 209c may be coupled to the first solar tracker row 202a via the fifth U-joint. For instance, the fifth U-joint may couple the third driveline 209c to the first gear drive mechanism 210a, and the first gear drive mechanism 210a may transmit the rotational force from the motor 212 to the fifth U-joint, which may transmit the rotational force to the third driveline 209c. The third driveline 209c may be coupled to the fourth solar tracker row via the sixth U-joint, and the third driveline 209c may transmit the rotational force to the sixth U-joint, which may transmit the rotational force to a fourth torque tube at the fourth solar tracker row. Thus, the third driveline assembly 208c may cause the fourth torque tube to rotate and one or more fourth PV modules to rotate at the fourth solar tracker row. Additional solar tracker rows 202 may be implemented in the same direction, and the rotational force may be transmitted to the additional solar tracker rows 202 using similar components.

Modifications, additions, or omissions may be made to the solar tracker system 200 without departing from the scope of the present disclosure. For example, the solar tracker system 200 may have more or less solar tracker rows 202 depending on the configuration of the solar tracker system 200. As illustrated, the first solar tracker row 202a having the motor 212 may be a middle row, but, in some embodiments, the first solar tracker row 202a may be an end row. In some embodiments, multiple motors 212 may be utilized.

Furthermore, the components illustrated in FIG. 2 and described with respect to FIG. 2, may be similar to, have similar features as, or perform similar functions as similarly named components described throughout this disclosure. For example, the U-joints 214 in the driveline assemblies 208 may be similar to the U-joints described throughout this disclosure and may utilize the bushings described throughout this disclosure.

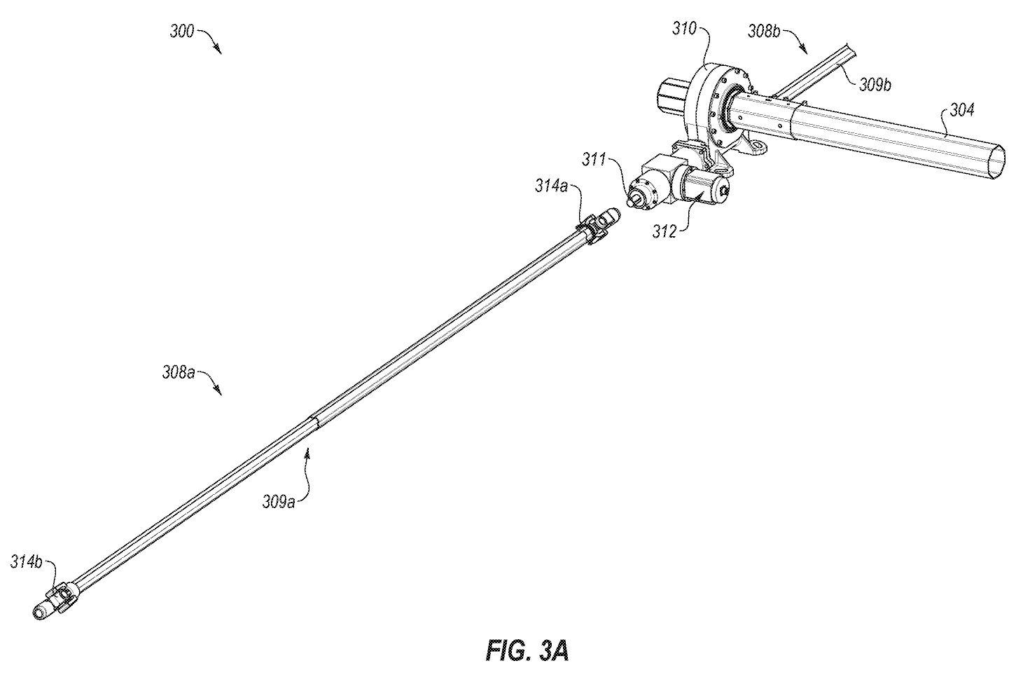

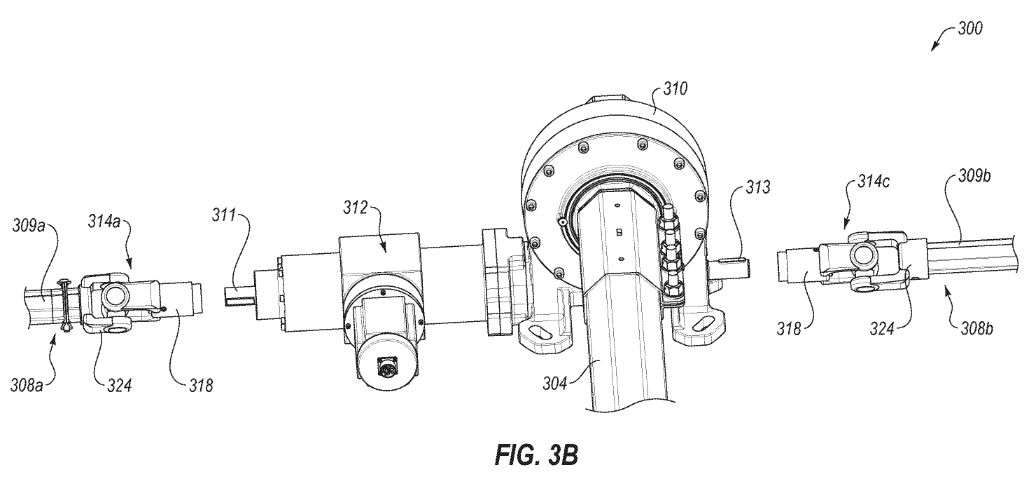

FIGS. 3A and FIG. 3B respectively illustrate a perspective exploded view of a solar tracker system 300, and a top exploded view of the solar tracker system 300. The solar tracker system 300 may include one or more driveline assemblies 308 and a motor 312. The motor 312 may be included at a first solar tracker row and may exert a rotational force that may be transmitted to other solar tracker rows utilizing the one or more driveline assemblies 308. The first solar tracker row may also include a gear drive mechanism 310 and a torque tube 304 coupled to one or more first PV modules (not shown) such that rotation of the torque tube 304 causes the first PV modules to rotate.

The motor 312 may be coupled on a first side to a first driveline assembly 308a. For example, the motor 312 may include a first driveshaft 311, which may be coupled to the first driveline assembly 308a. The rotational force of the motor 312 may rotate the first driveshaft 311, which may rotate the first driveline assembly 308a.

The motor 312 may be coupled on a second side to the gear drive mechanism 310. As illustrated in FIGS. 3A and 3B, the gear drive mechanism 310 may be a slew drive. The rotational force of the motor 312 may be transmitted to the gear drive mechanism 310. The gear drive mechanism 310 may transmit the rotational force from the motor 312 to the torque tube 304 causing the torque tube 304 to rotate, which may in turn cause the one or more PV modules (not shown) coupled to the torque tube 304 to rotate.

The first driveline assembly 308a may include a first U-joint 314a, a second U-joint 314a, and a first driveline 309a. The first U-joint 314a may couple one end of the first driveline 309a to the first solar tracker row. The first U-joint 314a may transmit the rotational force from the motor 312 to the first driveline 309a. For example, the rotational force from the motor 312 may cause the first driveshaft 311 to rotate, which may cause the first U-joint 314a to rotate thereby causing the first driveline 309a to rotate.

The first driveline 309a may be coupled to the second U-joint 314b at an end of the first driveline 309a opposite of the first U-joint 314a. The second U-joint 314b may couple the first driveline 309a to a second solar tracker row (not shown). In some embodiments, the second U-joint 314b may be coupled to a second driveshaft at the second solar tracker row. In some of these embodiments, the second driveshaft may be included in a second gear drive mechanism (not shown).

The second U-joint 314bmay be configured to transmit the rotational force from the first driveline 309a to the second solar tracker row. For example, rotation of the first driveline 309a may cause the second U-joint 314b to rotate, and the second U-joint 314b may rotate the driveshaft of the second gear drive mechanism at the second solar tracker row, which may cause a second torque tube at the second solar tracker row to rotate. As a result, one or more PV modules (not shown) at the second solar tracker row may rotate.

As illustrated in FIG. 3B, the gear drive mechanism 310 may include a third driveshaft 313. A second driveline assembly 308b may be coupled to the gear drive mechanism 310. For example, the second driveline assembly 308b may be coupled to the third driveshaft 313. The second driveline assembly 308b may include a third U-joint 314c, a fourth U-joint (not shown), and a second driveline 309b. The second driveline assembly 308b may be similar to and perform similar functions as the first driveline assembly 308a. The third U-joint 314c may couple the second driveline 309b to the first solar tracker row. For example, the third U-joint 314c may be coupled to the third driveshaft 313 of the gear drive mechanism 310 and the second driveline 309b. The rotational force exerted by the motor 312 may be transmitted from the gear drive mechanism 310 to the third U-joint 314c, which may transmit the rotational force to the second driveline 309b. For example, the rotational force exerted by the motor 312 may cause the third driveshaft 313 to rotate, which may rotate the third U-joint 314c, which may cause the second driveline 309b to rotate. The second driveline 309b may transmit the rotational force to the fourth U-joint, which may transmit the rotational force to a third torque tube at a third solar tracker row. For example, the fourth U-joint may be coupled to a third gear drive mechanism at the third solar tracker row, and rotation of the fourth U-joint may cause the third gear drive mechanism to rotate the third torque tube thereby rotating one or more third PV modules at the third solar tracker row.

The U-joints 314 may include a cross member including a central body, a first trunnion, a second trunnion, a third trunnion opposite the first trunnion, and a fourth trunnion opposite the second trunnion. Each trunnion may extend outwardly from the central body. The U-joints 314 may also include one or more bushings having a self-lubricating inner surface. For example, a first bushing may be coupled to the first trunnion, a second bushing may be coupled to the second trunnion, a third bushing may be coupled to the third trunnion, a fourth bushing may be coupled to the fourth trunnion, and each of the bushings may have a self-lubricating inner surface. The U-joints 314 may include a first yoke 318 that may be coupled to a driveshaft and a second yoke 324 that may be configured to be coupled to a driveline 309. For example, the first yoke 318 of the first U-joint 314a may be coupled to the first driveshaft 311 of the motor 312, and the second yoke 324 of the first U-joint 314a may be coupled to the first driveline 309a. In another example, the first yoke 318 of the third U-joint 314c may be coupled to the third driveshaft 313 of the gear drive mechanism 310, and the second yoke 324 of the third U-joint 314c may be coupled to the second driveline 309b.

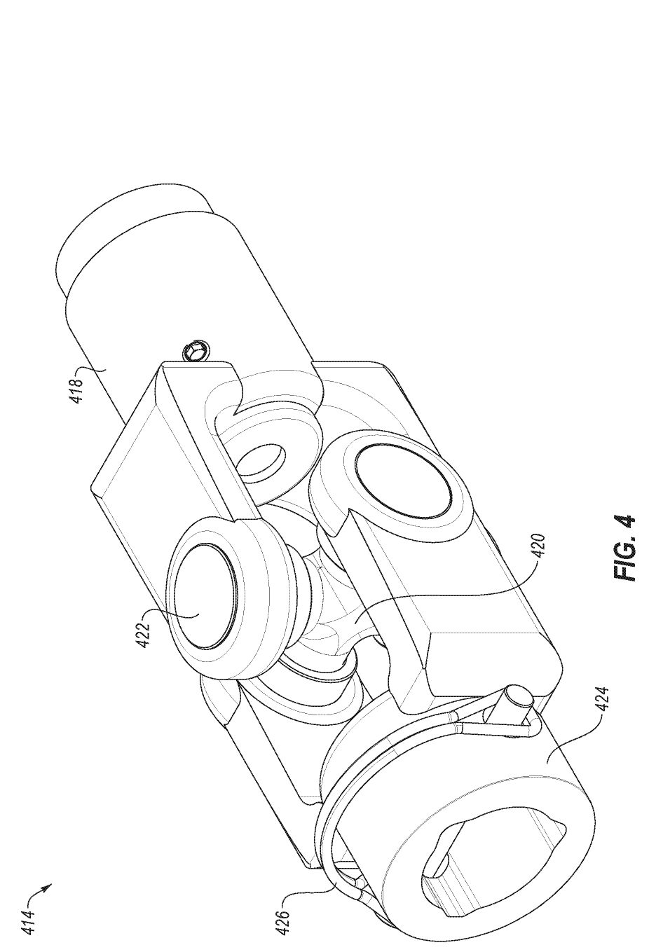

The first yoke 318 may include a first arm and a second arm, and the second yoke 324 may include a third arm and a fourth arm. Each arm may define an aperture. The aperture of the first arm may couple the first arm of the first yoke 318 to the first bushing, the aperture of the second arm may couple the second arm of the first yoke 318 to the third bushing, the aperture of the third arm may couple the third arm of the second yoke 324 to the second bushing, and the aperture of the fourth arm may couple the fourth arm of the second yoke 324 to the fourth bushing. As a result, the rotational force exerted by the motor 312 may be transmitted by the U-joint 314 to a driveline. For example, the rotational force exerted by the motor 312 may cause the first yoke 318 of the first U-joint 314a to rotate, the rotation of the first yoke 318 of the first U-joint 314a may cause the cross member to rotate, the rotation of the cross member may cause the second yoke 324 of the first U-joint 314a to rotate, and the rotation of the second yoke 324 of the first U-joint 314a may cause the first driveline 309a to rotate. The U-joints 314 are explained in more detail with reference to FIGS. 4–11.

Modifications, additions, or omissions may be made to the solar tracker system 300 without departing from the scope of the present disclosure. For example, multiple motors 312 and/or additional gear drive mechanisms 310 may be utilized. Additionally, the motor 312 may be placed at different solar tracker rows in the solar tracker system 300. For example, the motor 312 may be placed at a different solar tracker row than that shown in FIG. 3, and the first U-joint 314a may instead be coupled to the gear drive mechanism 310. For instance, the first U-joint 314a may be coupled to a fourth driveshaft of the gear drive mechanism 310 that may be opposite the third driveshaft 313.

Furthermore, the components illustrated in FIG. 3A and 3B and described in FIG. 3A and 3B, may be similar to, have similar features as, or perform similar functions as similarly named components described throughout this disclosure. For example, the U-joints 314 may be similar to the U-joints described throughout this disclosure and may utilize the bushings described throughout this disclosure.

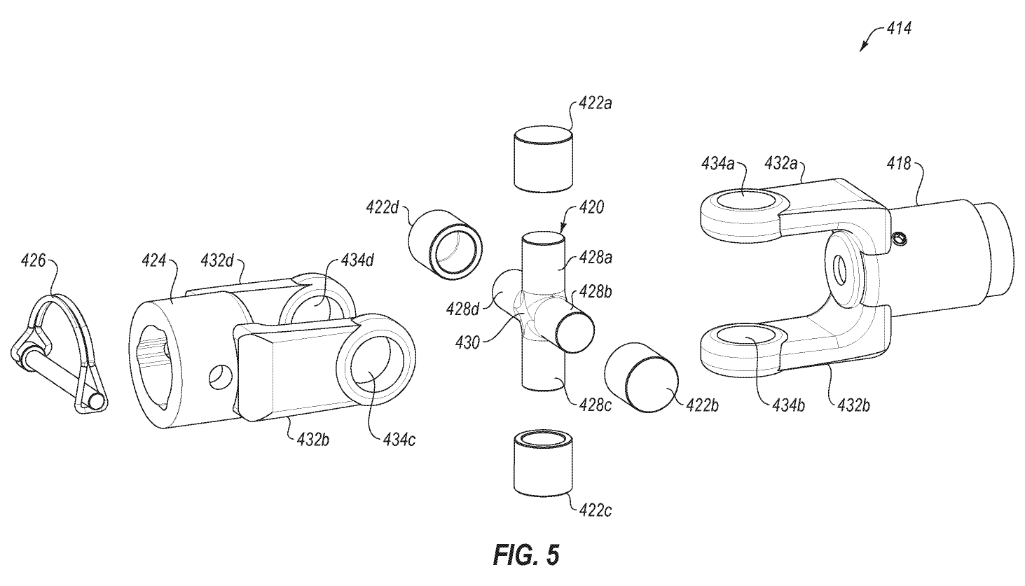

FIGS. 4 and FIG. 5 respectively illustrate a perspective view and an exploded view of a U-joint 414 including one or more bushings 422 with a self-lubricating inner surface. The U-joint 414 may be utilized in any of the solar tracker systems described throughout this disclosure. For example, the U-joint 414 may be utilized in the solar tracker systems 100, 200, or 300 of FIGS. 1, 2, 3A and 3B, respectively. As illustrated in FIG. 5, the U-joint 414 may include a cross member 420 having a central body 430. The cross member 420 may also include a first trunnion 428a, a second trunnion 428b, a third trunnion 428c opposite the first trunnion 428a, and a fourth trunnion 428d opposite the second trunnion 428b. Each of the trunnions 428 may extend outwardly from the central body 430.

A first bushing 422a may be coupled to the first trunnion 428a, a second bushing 422b may be coupled to the second trunnion 428b, a third bushing 422c may be coupled to the third trunnion 428c, and/or a fourth bushing 422d may be coupled to the fourth trunnion 428d. Each of the bushings 422 may have a self-lubricating inner-surface.

The U-joint 414 may further include a first yoke 418 and a second yoke 424. The first yoke 418 may be configured to be coupled to a driveshaft. For example, the first yoke 418 may be configured to be coupled to a driveshaft of a motor and/or a gear drive mechanism. The second yoke 424 may be configured to be coupled to a driveline. For example, the second yoke 424 may have a male coupling at one end of the second yoke 424 that a driveline may be configured to receive. In some embodiments, the second yoke 424 may have a female coupling at one end of the second yoke 424 that may be configured to receive the driveline.

The first yoke 418 may include a first arm 432a and a second arm 432b. The first arm 432a may define a first aperture 434a, and the second arm 432b may define a second aperture 434b. The first aperture 434a may couple the first arm 432a to the first bushing 422a and/or the first trunnion 428a. The second aperture 434b may couple the second arm 432b to the third bushing 422c and/or the third trunnion 428c.

The second yoke 424 may include a third arm 432d and a fourth arm 432d. The third arm 432c may define a third aperture 434c, and the fourth arm 432d may define a fourth aperture 434d. The third aperture 434d may couple the third arm 432c to the second bushing 422b and/or the second trunnion 428b. The fourth aperture 434d may couple the fourth arm 432d to the fourth bushing 422d and/or the fourth trunnion 428d.

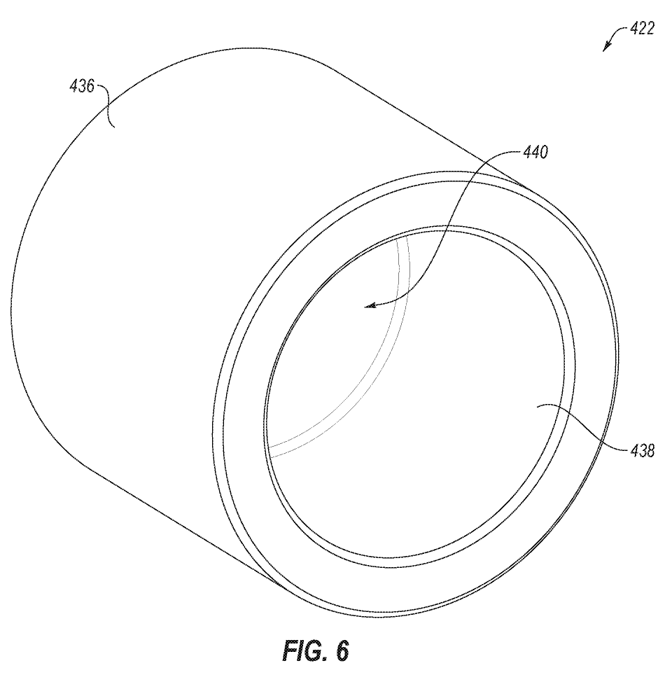

FIG. 6 illustrates the bushings 422 in more detail. As illustrated in FIG. 6, the bushings 422 may include an outer surface 436 and an inner surface 438. The inner surface 438 of the bushing 422 may contact the trunnion 428 coupled to the bushing 422 and may be self-lubricating. In some embodiments, the inner surface 438 may include a polymer, a lubricant, and/or a combination of polymer and lubricant. In some embodiments, the inner surface 438 may include PTFE, graphite, molybdenum disulfide, ultra-high molecular weight polyethylene (UHMWPE), polyoxymethylene (POM), and/or polyetheretherketone (PEEK), among other materials. For example, in some embodiments, the inner surface 438 may include a PTFE layer that may be applied to at least a portion of the inner surface 438. In some embodiments, the bushings 422 may include a metal backplane to which the PTFE layer may be applied. The metal backplane may be attached to the inner surface 438 and/or may form at least a portion of the inner surface 438. In some embodiments, the PTFE layer may be a PTFE tape, which may be applied to the metal backplane. In some embodiments, the PTFE layer may be a PTFE powder. In some embodiments a PTFE powder may be used, a porous metal layer may be attached to the metal backplane, and the PTFE powder may be applied to the porous metal layer. Additionally or alternatively, the PTFE powder may be applied to a stretched metal that may be attached to the metal backplane.

In some embodiments and as illustrated in FIG. 6, the bushing 422 may be a cap having a blind hole 440. In these and other embodiments, any of the first bushing 422a, the second bushing 422b, the third bushing 422c, and/or the fourth bushing 422d may be a cap having the blind hole 440. For example, the blind hole 440 of the first bushing 422a may receive the first trunnion 428a, the blind hole 440 of the second bushing 422b may receive the second trunnion 428b, the blind hole 440 of the third bushing 422c may receive the third trunnion 428c, and/or the blind hole 440 of the fourth bushing 422d may receive the fourth trunnion 428d. While depicted as being cylindrical, the bushings 422 may have any suitable shape that may receive the trunnions 428.

In an example operation of the U-joint 414 including one or more bushings 422 having the self-lubricating inner surface 438, the first yoke 418 may be coupled to a driveshaft, and the driveshaft may transmit a rotational force to the first yoke 418 causing the first yoke 418 to rotate. For example, the first yoke 418 may be coupled to a driveshaft of a motor, and the rotational force exerted by the motor may cause the first yoke 418 to rotate. The first yoke 418 may transmit the rotational force to the cross member 420 coupled to the first arm 432a and the second arm 432b of the first yoke 418, which may cause the cross member 420 to rotate. The cross member 420 may transmit the rotational force to the second yoke 424, which may be coupled to the cross member 420 at the third arm 432c and the fourth arm 432d of the second yoke 424. The rotational force transmitted from the cross member 420 to the second yoke 424 may cause the second yoke 424 to rotate. The second yoke 424 may be coupled to a driveline and may transmit the rotational force to the driveline.

As the U-joint 414 rotates, the friction between the trunnions 428 and the inner surface 438 of the bushings 422 may cause the polymer and/or lubricant on the inner surface 438 to be released, which may lubricate the bushings 422 and/or the trunnions 428. For example, as the trunnions 428 move relative to the bushings 422 and/or the bushings 422 move relative to the trunnions 428, PTFE from a PTFE layer applied to the inner surface 438 of the bushings 422 may be released onto the surface of the trunnions 428 contacting the bushings 422, which may lubricate the bushings 422 and/or the trunnions 428 as the trunnions 428 and/or the bushings 422 continue to rotate.

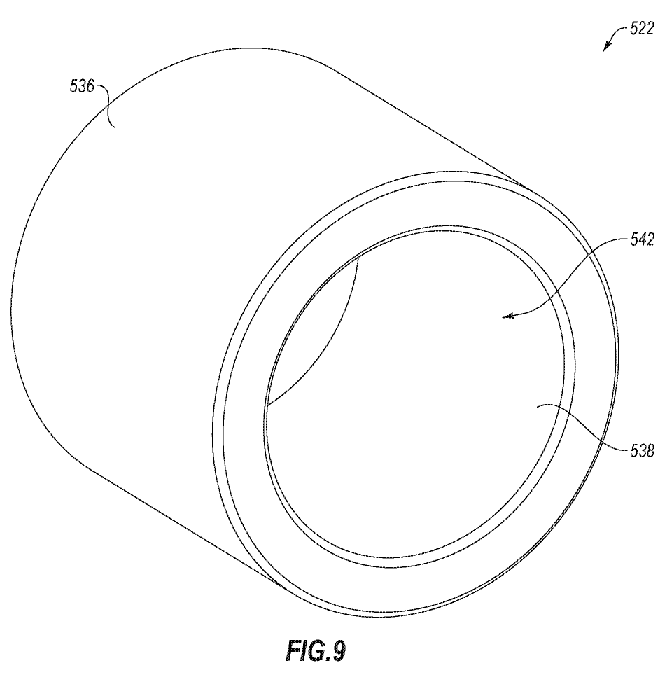

Modifications, additions, or omissions may be made to the U-joint 414 illustrated in FIGS. 4–5 and/or the bushings 422 illustrated in FIGS. 4–6 without departing from the scope of the present disclosure. For example, in some embodiments, some of the bushings 422 may not include a self-lubricating inner surface. For instance, the first bushing 422a and the third bushing 422c may be needle bearings but the second bushing 422b and the fourth bushing 422d may have a self-lubricating inner surface. Furthermore, the bushings 422 illustrated are shown as caps having a blind hole 440; however, the bushings 422 may be configured in any suitable manner. For example, the bushings 422 may be a sleeve (e.g., a plain bushing) having a through hole as explained with reference to FIG. 9. In another example, the bushings 422 may be flanged bushings, split bushings, or other bushings that may utilize a self-lubricating inner surface.

Moreover, in some embodiments, the U-joint 414 may include a retention mechanism 426 that may retain the coupling between the U-joint 414 and the driveline while the U-joint 414 and/or the driveline rotates. In some embodiments, the retention mechanism 426 may be a retention pin (as illustrated in FIGS. 4 and 5), a clamp, a friction-fit, a wedge fit, a rivet, a snap ring, a magnet, an adhesive, or any other suitable retention mechanism. Furthermore, in some embodiments, the U-joint 414 may have male or female threads, the driveline may have corresponding threads, and the U-joint 414 and the driveline may be threadably coupled together. In these and other embodiments, the retention mechanism 426 may be omitted. Moreover, while the first yoke 418 of the U-joint 414 is shown as being configured to be coupled to a driveshaft, it will be appreciated that the first yoke 418 may be configured to be coupled to other components which may transmit a rotational force to the U-joint 414 or other components to which the U-joint 414 may transmit a rotational force. While the second yoke 424 of the U-joint 414 is shown as being configured to be coupled to a driveline, it will be appreciated that the second yoke 424 may be configured to be coupled to other components to which the U-joint 414 may transmit a rotational force or other components which may transmit a rotational force to the U-joint 414.

Furthermore, the components illustrated in FIGS. 4–6 and described in FIGS. 4–6, may be similar to, have similar features as, or perform similar functions as similarly named components described throughout this disclosure. For example, the U-joints 414 may be similar to the U-joints described throughout this disclosure.

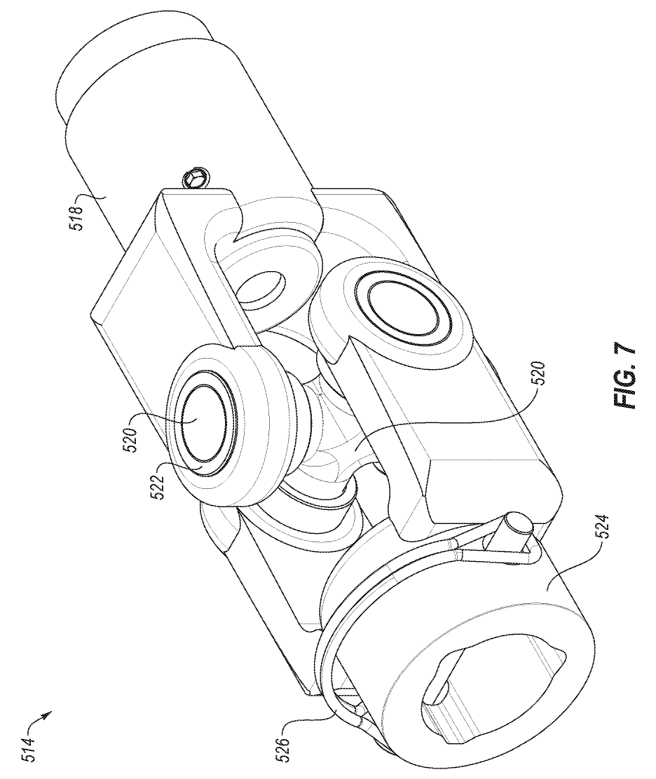

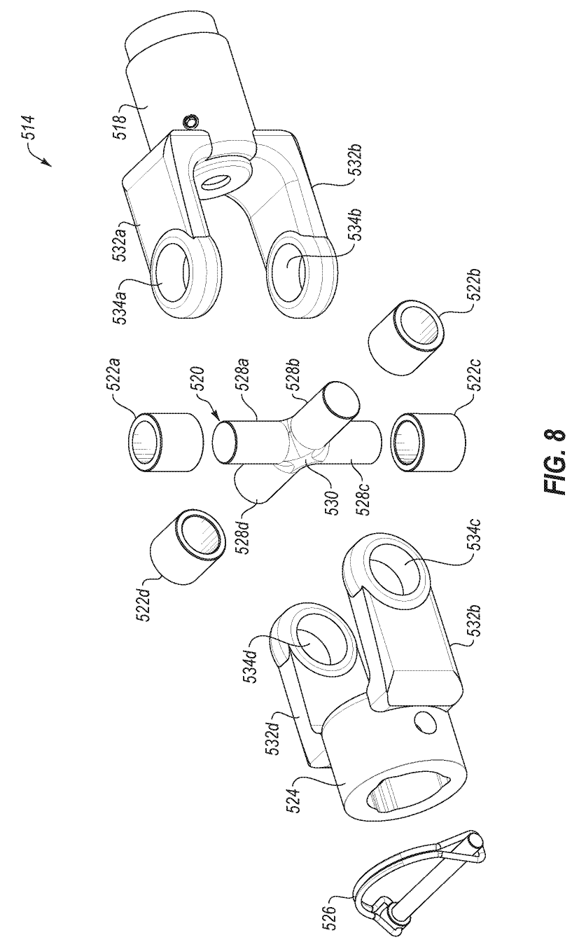

FIGS. 7 and FIG. 8 respectively illustrate a perspective view and an exploded view of a U-joint 514 including one or more bushings 522 with a self-lubricating inner surface. The U-joint 514 may be utilized in any of the solar tracker systems described throughout this disclosure. For example, the U-joint 514 may be utilized in the solar tracker systems 100, 200, or 300 of FIGS. 1, 2, 3A and 3B, respectively. As illustrated in FIG. 8, the U-joint 514 may include a cross member 520 having a central body 530. The cross member 520 may also include a first trunnion 528a, a second trunnion 528b, a third trunnion 528c opposite the first trunnion 528a, and a fourth trunnion 528d opposite the second trunnion 528b. Each of the trunnions 528 may extend outwardly from the central body 530.

A first bushing 522a may be coupled to the first trunnion 528a, a second bushing 522b may be coupled to the second trunnion 528b, a third bushing 522c may be coupled to the third trunnion 528c, and/or a fourth bushing 522d may be coupled to the fourth trunnion 528d. Each of the bushings 522 may have a self-lubricating inner-surface.

The U-joint 514 may further include a first yoke 518 and a second yoke 524. The first yoke 518 may be configured to be coupled to a driveshaft. For example, the first yoke 518 may be configured to be coupled to a driveshaft of a motor and/or a gear drive mechanism. The second yoke 524 may be configured to be coupled to a driveline. For example, the second yoke 524 may have a male coupling at one end of the second yoke 524 that a driveline may be configured to receive. In some embodiments, the second yoke 524 may have a female coupling at one end of the second yoke 524 that may be configured to receive the driveline.

The first yoke 518 may include a first arm 532a and a second arm 532b. The first arm 532a may define a first aperture 534a, and the second arm 532b may define a second aperture 534b. The first aperture 534a may couple the first arm 532a to the first bushing 522a and/or the first trunnion 528a. The second aperture 534b may couple the second arm 532b to the third bushing 522c and/or the third trunnion 528c.

The second yoke 524 may include a third arm 532c and a fourth arm 532d. The third arm 532c may define a third aperture 534c, and the fourth arm 532d may define a fourth aperture 534d. The third aperture 534c may couple the third arm 532c to the second bushing 522b and/or the second trunnion 528b. The fourth aperture 534d may couple the fourth arm 532d to the fourth bushing 522d and/or the fourth trunnion 528d.

FIG. 9 illustrates the bushings 522 in more detail. As illustrated in FIG. 9, the bushings 522 may include an outer surface 536 and an inner surface 538. The inner surface 538 of the bushing 522 may contact the trunnion 528 coupled to the bushing 522 and may be self-lubricating. In some embodiments, the inner surface 538 may include a polymer, a lubricant, and/or a combination of polymer and lubricant. In some embodiments, the inner surface 538 may include PTFE, graphite, molybdenum disulfide, UHMWPE, POM, and/or PEEK, among other materials. For example, in some embodiments, the inner surface 538 may include a PTFE layer that may be applied to at least a portion of the inner surface 538. In some embodiments, the bushings 522 may include a metal backplane to which the PTFE layer may be applied. The metal backplane may be attached to the inner surface 538 and/or may form a portion of the inner surface 538. In some embodiments, the PTFE layer may be a PTFE tape, which may be applied to the metal backplane. In some embodiments, the PTFE layer may be a PTFE powder. In some embodiments a PTFE powder may be used, a porous metal layer may be attached to the metal backplane, and the PTFE powder may be applied to the porous metal layer. Additionally or alternatively, the PTFE powder may be applied to a stretched metal that may be attached to the metal backplane.

In some embodiments and as illustrated in FIG. 9, the bushing 522 may be a sleeve having a through hole 542. In these and other embodiments, any of the first bushing 522a, the second bushing 522b, the third bushing 522c, and/or the fourth bushing 522d may be a sleeve having the through hole 542. For example, the through hole 542 of the first bushing 522a may receive the first trunnion 528a, the through hole 542 of the second bushing 522b may receive the second trunnion 528b, the through hole 542 of the third bushing 522c may receive the third trunnion 528c, and/or the through hole 542 of the fourth bushing 522d may receive the fourth trunnion 528d. While depicted as being cylindrical, the bushings 522 may have any suitable shape that may receive the trunnions 528.

In an example operation of the U-joint 514 including one or more bushings 522 with the self-lubricating inner surface 538, the first yoke 518 may be coupled to a driveshaft, and the driveshaft may transmit a rotational force to the first yoke 518 causing the first yoke 518 to rotate. For example, the first yoke 518 may be coupled to a driveshaft of a motor, and the rotational force exerted by the motor may cause the first yoke 518 to rotate. The first yoke 518 may transmit the rotational force to the cross member 520 coupled to the first arm 532a and the second arm 532b of the first yoke 518, which may cause the cross member 520 to rotate. The cross member 520 may transmit the rotational force to the second yoke 524, which may be coupled to the cross member 520 at the third arm 532c and the fourth arm 532d of the second yoke 524. The rotational force transmitted from the cross member 520 to the second yoke 524 may cause the second yoke 524 to rotate. The second yoke 524 may be coupled to a driveline and may transmit the rotational force to the driveline.

As the U-joint 514 rotates, the friction between the trunnions 528 and the inner surface 538 of the bushings 522 may cause the polymer and/or lubricant on the inner surface 538 to be released, which may lubricate the bushings 522 and/or the trunnions 528. For example, as the trunnions 528 move relative to the bushings 522 and/or the bushings 522 move relative to the trunnions 528, PTFE from a PTFE layer applied to the inner surface 538 of the bushings 522 may be released onto the surface of the trunnions 528 contacting the bushings 522, which may lubricate the bushings 522 and/or the trunnions 528 as the trunnions 528 and/or the bushings 522 continue to rotate.

Modifications, additions, or omissions may be made to the U-joint 514 illustrated in FIGS. 7–8 and/or the bushings 522 illustrated in FIGS. 7–9 without departing from the scope of the present disclosure. For example, in some embodiments, some of the bushings 522 may not include a self-lubricating inner surface. For instance, the first bushing 522a and the third bushing 522c may be needle bearings but the second bushing 522b and the fourth bushing 522d may have a self-lubricating inner surface. Furthermore, the bushings 522 illustrated are shown as sleeves having a through hole 542; however, the bushings 522 may be configured in any suitable manner. For example, the bushings 522 may be a cap having a blind hole as explained with reference to FIG. 6. In another example, the bushings 522 may be flanged bushings, split bushings, or other bushings that may utilize a self-lubricating inner surface.

Moreover, in some embodiments, the U-joint 514 may include a retention mechanism 526 that may retain the coupling between the U-joint 514 and the driveline while the U-joint 514 and/or the driveline rotates. In some embodiments, the retention mechanism 526 may be a retention pin (as illustrated in FIGS. 7–8), a clamp, a friction-fit, a wedge fit, a rivet, a snap ring, a magnet, an adhesive, or any other suitable retention mechanism. Furthermore, in some embodiments, the U-joint 514 may have male or female threads, the driveline may have corresponding threads, and the U-joint 514 and the driveline may be threadably coupled together. In these and other embodiments, the retention mechanism 526 may be omitted. Moreover, while the first yoke 518 of the U-joint 514 is shown as being configured to be coupled to a driveshaft, it will be appreciated that the first yoke 518 may be configured to be coupled to other components which may transmit a rotational force to the U-joint 514 or other components to which the U-joint 514 may transmit a rotational force. While the second yoke 524 of the U-joint 514 is shown as being configured to be coupled to a driveline, it will be appreciated that the second yoke 524 may be configured to be coupled to other components to which the U-joint 514 may transmit a rotational force or other components which may transmit a rotational force to the U-joint 514.

Furthermore, the components illustrated in FIGS. 7–9 and described in FIGS. 7–9, may be similar to, have similar features as, or perform similar functions as similarly named components described throughout this disclosure. For example, the U-joints 514 may be similar to the U-joints described throughout this disclosure.

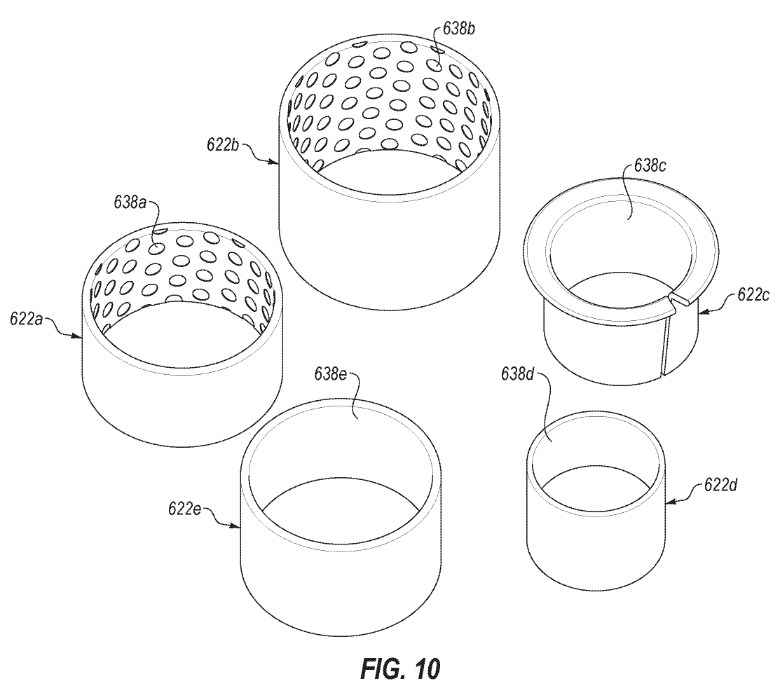

FIG. 10 shows various configurations of a bushing 622 having a self-lubricating inner surface 638. FIG. 10 illustrates a first bushing 622a, a second bushing 622b, a third bushing 622c, a fourth bushing 622d, and a fifth bushing 622e with each having at least a partially different configuration. The bushings 622 may each include self-lubricating inner surface 638. For example, the first bushing 622a may have a first self-lubricating inner surface 638a. The bushings 622 may be utilized in a solar tracker system such as the solar tracker systems 100, 200, or 300 of FIGS. 1, 2, 3A and 3B, respectively.

Each of the bushings 622 is shown as a cylindrical bushing; however, it will be appreciated that the bushings 622 may be any shape that may receive the trunnions of the cross member. Additionally, each of the bushings 622 is shown as having a split bushing configuration, however it will be appreciated that, in some embodiments, the bushings 622 may have a solid bushing configuration. For example, the bushings 422 described with reference to FIG. 4 and the bushings 522 described with reference to FIG. 5 are both illustrated as solid bushings.

The first self-lubricating inner surface 638a of the first bushing 622a may include a metal backplane and a POM composite layer. The POM composite layer may include pockets that act as reservoirs for lubricant and the lubricant may be released from the POM composite layer as the first bushing 622a rotates and/or as a trunnion rotates in the first bushing 622a.

A second self-lubricating inner surface 638b of the second bushing 622b may include a wrapped bronze layer that may be attached to a metal backplane. The wrapped bronze may form a thin oxide layer and build a lubricating film when the second bushing 622b rotates and/or a trunnion rotates in the second bushing 622b, The wrapped bronze layer on the inner surface 638b may include pockets that may act as reservoirs and be filled with lubricant prior to installation (e.g., grease prior to installation) and/or may be filled by the lubricating film created by the wrapped bronze layer during use of the second bushing 622b.

The third bushing 622c, the fourth bushing 622d, and the fifth bushing 622e each illustrate that the self-lubricating inner surface 638 may include a PTFE layer. In some embodiments, the PTFE layer may be a PTFE tape or a PTFE powder. The third bushing 622c, the fourth bushing 622d, and the fifth bushing 622e may include a metal backplane to which the PTFE layer may be applied. In some embodiments, the PTFE layer may be applied to a porous metal layer attached to the metal backplane. For example, a layer of tin/bronze may be sintered onto the metal backplane, and a PTFE powder may be rolled onto the sintered layer such that the PTFE powder may enter the pores of the sintered layer. In some embodiments, the PTFE layer may be applied to a stretched metal. The stretched metal layer may have a mesh-like or porous structure allowing the PTFE layer to enter the stretched metal layer. The third bushing 622c illustrates a flanged configuration, and the fourth and fifth bushings 622d and 622e illustrate a straight bushing configuration (i.e., non-flanged) The fourth bushing 622d and the fifth bushing 622e illustrate that various sizes of bushings 622 may be utilized depending on the size of the trunnions of the crossmember utilized in the U-joint.

Modifications, additions, or omissions may be made to the bushings 622 without departing from the scope of the present disclosure. For example, the bushings 622 may have different shapes and/or sizes depending on the size of the cross member and the trunnions extending from the cross member. Furthermore, the bushings 622 may have different configurations than those shown in FIG. 10. For example, the self-lubricating inner surface 638 may include molybdenum disulfide, UHMWPE, and/or PEEK in addition to POM and/or PTFE or instead of POM and/or PTFE.

Furthermore, the components illustrated in FIG. 10 and described in FIG. 10 may be similar to, have similar features as, or perform similar functions as similarly named components described throughout this disclosure. For example, the bushings 622 may be utilized in U-joints described throughout this disclosure.

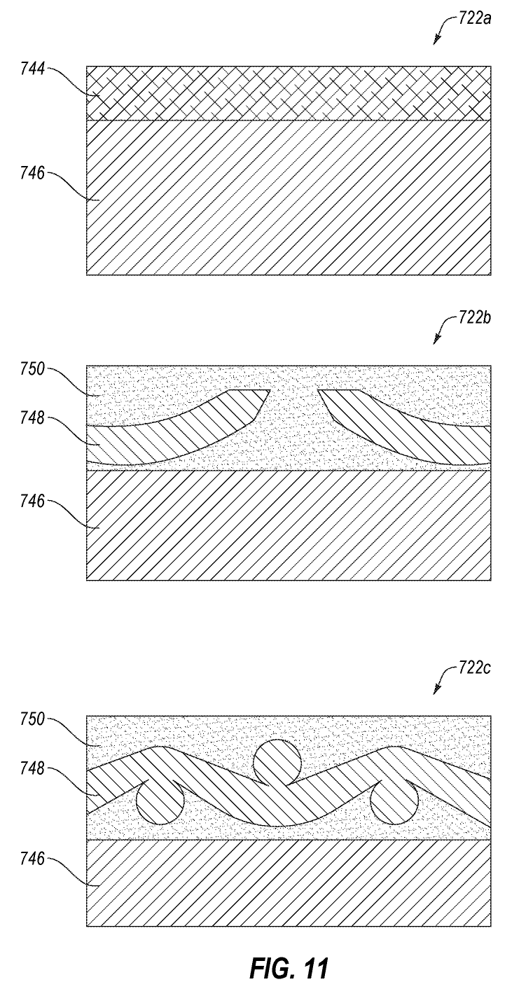

FIG. 11 illustrates various cross-sectional views layers that may be included in a bushing 722 having a self-lubricating inner surface. As illustrated in FIG. 11, a first bushing 722a, a second bushing 722b, and/or a third bushing 722c may include a metal backplane 746.

In some embodiments, a polymer and/or a lubricant may be applied to the metal backplane 746. For example, in some embodiments, the first bushing 722a may include a PTFE tape 744 applied directly to the metal backplane 746. In these and other embodiments, the PTFE in the PTFE tape 744 may be released as a result of rotation of the first bushing 722a and/or as a result of rotation of the trunnion to which the first bushing 722a may be coupled.

In some embodiments, a stretched metal 748 may be applied to the metal backplane 746, and a polymer and/or lubricant may be applied to the stretched metal 748. For example, the second bushing 722b may include a PTFE powder 750 that may be applied to the stretched metal 748 attached to the metal backplane 746. The stretched metal 748 may have a mesh-like and/or porous structure that may allow the PTFE powder 750 to enter the stretched metal 748 of the second bushing 722b. In these and other embodiments, the PTFE powder 750 may be released from the stretched metal 748 as a result of rotation of the second bushing 722b and/or as a result of rotation of the trunnion to which the second bushing 722b may be coupled.

In some embodiments, a porous metal layer 752 may be applied to the metal backplane 746, and a polymer and/or lubricant may be applied to the porous metal layer. For example, the third bushing 722c may include the porous metal layer 752 such as a sintered metal, and the PTFE powder 750 may be applied to the porous metal layer 752. The pores of the porous metal layer 752 may allow the PTFE powder 750 to enter the porous metal layer 752. In these and other embodiments, the PTFE powder 750 may be released from the porous metal layer 752 as a result of rotation of the third bushing 722c and/or as a result rotation of the trunnion to which the third bushing 722c may be coupled.

Therefore, the bushings 722 and the bushings described throughout this disclosure may allow for self-lubrication of the U-joint in a solar tracker system, which may eliminate the need for manual lubrication, extend the life of the U-joint, and/or reduce the amount of U-joint maintenance over the life of the U-joint. Consequently, U-joint performance and longevity in solar tracker systems may be improved, which may reduce costs and enhance the overall reliability of solar tracker systems. Furthermore, the bushings 722 and the bushings described throughout this disclosure may eliminate the need for needle bearings, which may increase the torque capacity of U-joints utilized in solar tracker systems relative to the needle bearings currently used. This may enable the U-joint and the bushings 722 to operate more efficiently in high torque, low RPM conditions often encountered in solar tracker systems.

Modifications, additions, or omissions may be made to the bushings 722 without departing from the scope of the present disclosure. For example, while PTFE tape 744 and PTFE powder 750 is illustrated, it will be appreciated that other polymers and/or lubricants may be used. For instance, the bushings 722 may include POM, molybdenum disulfide, UHMWPE, and/or PEEK in addition to a PTFE or instead of a PTFE.

Furthermore, the components illustrated in FIG. 11 and described in FIG. 11 may be similar to, have similar features as, or perform similar functions as similarly named components described throughout this disclosure. For example, the bushings 722 may be utilized in U-joints described throughout this disclosure.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more" to introduce claim recitations.

In addition, even if a specific number of an introduced claim recitation is explicitly recited, those skilled in the art will recognize that such recitation should be interpreted to mean at least the recited number (e.g., the bare recitation of "two recitations," without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A universal-joint (U-joint) for a solar tracker system, the U-joint comprising:
a cross member including a central body, a first trunnion, a second trunnion, a third trunnion opposite the first trunnion, and a fourth trunnion opposite the second trunnion, each trunnion extending outwardly from the central body;
a first bushing coupled to the first trunnion, a second bushing coupled to the second trunnion, a third bushing coupled to the third trunnion, and a fourth bushing coupled to the fourth trunnion, each bushing having a self-lubricating inner surface;
a first yoke configured to be coupled to a driveshaft, the first yoke including a first arm and a second arm, each arm defining an aperture, the aperture of the first arm coupling the first arm to the first bushing and the aperture of the second arm coupling the second arm to the third bushing; and
a second yoke configured to be coupled to a driveline, the second yoke including a third arm and a fourth arm, each arm defining an aperture, the aperture of the third arm coupling the third arm to the second bushing and the aperture of the fourth arm coupling the fourth arm to the fourth bushing.

2. The U-joint of claim 1, wherein each bushing is a cap having a blind hole, the blind hole of the first bushing receiving the first trunnion, the blind hole of the second bushing receiving the second trunnion, the blind hole of the third bushing receiving the third trunnion, and the blind hole of the fourth bushing receiving the fourth trunnion.

3. The U-joint of claim 1, wherein each bushing is a sleeve having a through hole, the through hole of the first bushing receiving the first trunnion, the through hole of the second bushing receiving the second trunnion, the through hole of the third bushing receiving the third trunnion, and the through hole of the fourth bushing receiving the fourth trunnion.

4. The U-joint of claim 1, wherein the self-lubricating inner surface of each bushing includes a layer of at least one of: polytetrafluoroethylene (PTFE), molybdenum disulfide, ultra-high molecular weight polyethylene (UHMWPE), polyoxymethylene (POM), or polyetheretherketone (PEEK).

5. The U-joint of claim 4, wherein the self-lubricating inner surface of each bushing includes a PTFE layer.

6. The U-joint of claim 5, wherein each bushing includes a metal backplane to which the PTFE layer is applied.

7. The U-joint of claim 6, wherein the PTFE layer is a PTFE tape.

8. The U-joint of claim 6, wherein the PTFE layer is a PTFE powder.

9. The U-joint of claim 8, wherein the PTFE powder is applied to a porous metal layer attached to the metal backplane.

10. The U-joint of claim 8, wherein the PTFE powder is applied to a stretched metal attached to the metal backplane.

11. A solar tracker system, the solar tracker system comprising:
a photovoltaic (PV) module coupled to a torque tube such that rotation of the torque tube rotates the PV module;
a motor configured to generate a rotational force;
a driveline assembly coupled to the motor, the driveline assembly comprising:
a driveline configured to transmit the rotational force from the motor to the torque tube such that the rotational force causes the torque tube to rotate; and
a universal-joint (U-joint) configured to transmit the rotational force from the motor to the driveline, the U-joint comprising:
a cross member including a central body, a first trunnion, a second trunnion, a third trunnion opposite the first trunnion, and a fourth trunnion opposite the second trunnion, each trunnion extending outwardly from the central body;
a first bushing coupled to the first trunnion, a second bushing coupled to the second trunnion, a third bushing coupled to the third trunnion, and a fourth bushing coupled to the fourth trunnion, each bushing having a self-lubricating inner surface;
a first yoke coupled to the motor, the first yoke including a first arm and a second arm, each arm defining an aperture, the aperture of the first arm coupling the first arm to the first bushing and the aperture of the second arm coupling the second arm to the third bushing; and
a second yoke coupled to the driveline, the second yoke including a third arm and a fourth arm, each arm defining an aperture, the aperture of the third arm coupling the third arm to the second bushing and the aperture of the fourth arm coupling the fourth arm to the fourth bushing.

12. The solar tracker system of claim 11, wherein each bushing is a cap having a blind hole, the blind hole of the first bushing receiving the first trunnion, the blind hole of the second bushing receiving the second trunnion, the blind hole of the third bushing receiving the third trunnion, and the blind hole of the fourth bushing receiving the fourth trunnion.

13. The solar tracker system of claim 11, wherein each bushing is a sleeve having a through hole, the through hole of the first bushing receiving the first trunnion, the through hole of the second bushing receiving the second trunnion, the through hole of the third bushing receiving the third trunnion, and the through hole of the fourth bushing receiving the fourth trunnion.

14. The solar tracker system of claim 11, wherein the self-lubricating inner surface of each bushing includes a layer of at least one of: polytetrafluoroethylene (PTFE), molybdenum disulfide, ultra-high molecular weight polyethylene (UHMWPE), polyoxymethylene (POM), or polyetheretherketone (PEEK).

15. The solar tracker system of claim 14, wherein the self-lubricating inner surface of each bushing includes a PTFE layer.

16. The solar tracker system of claim 15, wherein each bushing includes a metal backplane to which the PTFE layer is applied.

17. The solar tracker system of claim 16, wherein the PTFE layer is a PTFE tape.

18. The solar tracker system of claim 16, wherein the PTFE layer is a PTFE powder.

19. The solar tracker system of claim 18, wherein the PTFE powder is applied to a porous metal layer attached to the metal backplane.

20. The solar tracker system of claim 18, wherein the PTFE powder is applied to a stretched metal attached to the metal backplane.
